(19) United States
(12) Patent Application Publication
(10) Pub. No.: US 2014/0285387 A1
(43) Pub. Date: Sep. 25, 2014

(54) BROADBAND MONOPOLE ANTENNA FOR VEHICLES FOR TWO FREQUENCY BANDS IN THE DECIMETER WAVELENGTH SPECTRUM SEPARATED BY A FREQUENCY GAP

(71) Applicant: DELPHI DEUTSCHLAND GmbH, WUPPERTAL (DE)

(72) Inventors: STEFAN LINDENMEIER, GAUTING-BUCHENDORF (DE); HEINZ LINDENMEIER, PLANEGG (DE); JOCHEN HOPF, HAAR (DE); LEOPOLD REITER, GILCHING (DE)

(21) Appl. No.: 14/221,669

(22) Filed: Mar. 21, 2014

(30) Foreign Application Priority Data
Mar. 24, 2013 (DE) 102013005001.4

(51) Int. Cl. H01Q 1/27; H01Q 5/00

(52) U.S. Cl. CPC H01Q 1/27; H01Q 5/002
USPC 343/713

(57) ABSTRACT

The invention relates to a vertical broadband monopole antenna for vehicles for two frequency bands separated by a frequency gap—the lower band for the lower frequencies and the upper band for the higher frequencies—both lying in the decimeter wavelength spectrum, and for transmitting and/or receiving using terrestrially broadcast, vertically polarized radio signals over a substantially horizontal conductive base surface adapted as a vehicle ground, having an antenna connection site located in the monopole nadir. The broadband monopole antenna is formed in combined form from an upper band monopole and a lower band monopole and from an electrically conductive planar structure above a conductive base surface substantially designed extending in a plane oriented perpendicular thereto.

The invention relates to a vertical broadband monopole antenna for vehicles for two frequency bands separated by a frequency gap—the lower band for the lower frequencies and the upper band for the higher frequencies—both disposed in the decimeter wavelength spectrum—and for transmitting and/or receiving using terrestrially broadcast, vertically polarized radio signals over a substantially horizontal conductive base surface 6 adapted as a vehicle ground, having an antenna connection site 3 located in the monopole nadir comprising an antenna connection point 5 and a ground connection 7.

Such broadband antennas are known from the prior art. These antennas are designed as multi-resonant rod antennas, wherein the coverage of a plurality of frequency bands separated from one another in frequency by frequency gaps takes place using multiple wire windings which are applied to the elongate rod and which partly overlap. Such antennas are used for transmitting and receiving in the decimeter wavelength spectrum, preferably on the vehicle roof respectively. Antennas of this kind have the disadvantage, on the one hand, that they are only provided for relatively narrow band frequency bands separated from one another by frequency gaps and can only be considered for wide frequency bands with great limitations. The construction height, their aerodynamic shape and their resistance value are in particular of importance for the use on vehicles. What is of special importance, however, is the economy of manufacture of such an antenna due to the large volumes customary in automotive construction. It has been shown in this respect that the application of different wire windings has to be subject to very tight tolerances mechanically for the required frequency precision to be achieved. Furthermore, the application of the windings onto the rod, their fastening and the establishing of their long term resistance and the reproducibility of the performance capability of the antenna are comparative complicated and economically expensive.

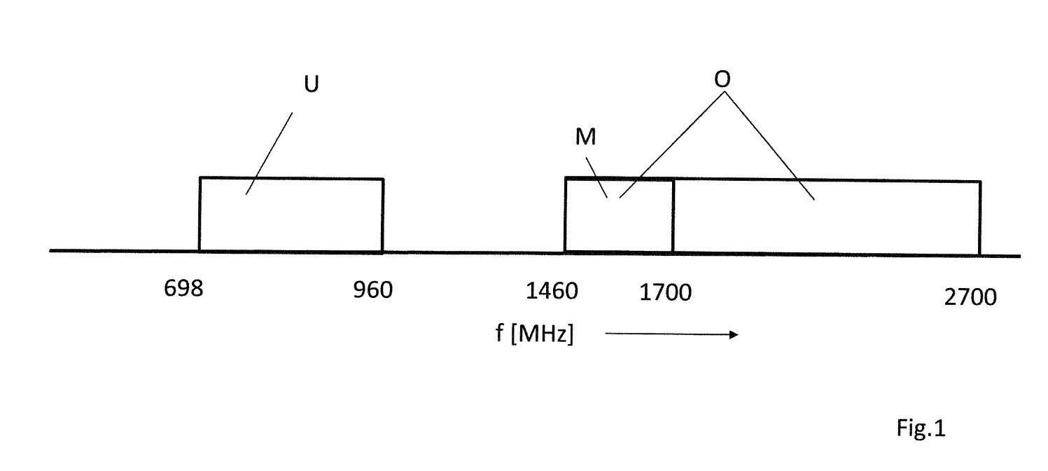

The high number of modern cellular networks such as in accordance with the mobile communication standard LTE (Long Term Evolution) or still in development requires antennas having extreme bandwidths. For example, a frequency range between 698 and 960 MHz—called lower band U in the following—is provided for the LTE mobile communication standard and the frequency range called the upper band O in the following here between 1460 MHz and 2700 MHz is provided above a frequency gap, as shown in FIG. 1. A middle band M in the frequency range between 1460 MHz and 1700 MHz is frequently additionally provided which is to be associated with the upper band. With respect to the antenna function, the frequency gap between the lower band U and the upper band O is desired for protection against the radio services located there. Antennas are required for this application which are suitable for vehicles, in addition to the electrical function, with economy of manufacture having a special importance.

It is therefore the object of the invention to provide an antenna for frequency bands separated by a frequency gap which has the required mechanical stability with a small construction height and favorable aerodynamic properties and which can above all be manufactured in an economically less expensive manner in a simple manufacturing process.

This object is satisfied by the features of claim 1.

Advantageous embodiments of the invention are described in the dependent claims and in the description.

The antenna can comprise a vertical broadband monopole antenna for vehicles for two frequency bands separated by a frequency gap—the lower band for the lower frequencies and the upper band for the higher frequencies—both lying in the decimeter wavelength spectrum—and for transmitting and/or receiving using terrestrially broadcast, vertically polarized radio signals over a substantially horizontal conductive base surface 6 adapted as a vehicle ground, having an antenna connection site 3 located in the monopole nadir and comprising an antenna connection point 5.

The broadband monopole antenna 0 can be formed in combined form from an upper band monopole 1 and a lower band monopole and is designed, for example, from a mechanically stiff, electrically conductive film 33 as a contiguous, electrically conductive and, for example, planar structure above a conductive base surface 6 extending substantially in a plane oriented perpendicular thereto. A triangular structure 4 standing at its apex and flat, for example, can be present at the lower end of the broadband monopole antenna 0 as an upper band monopole 1 having a substantially horizontally oriented baseline in an upper band monopole height 8 above the conductive base surface 6 and its apex is connected to the antenna connection point 5.

A roof capacitor 10 substantially designed as a rectangular structure 16, in particular as a planar rectangular structure, is adjacent to and below the upper end of the broadband monopole antenna 0 located in the antenna height 9 above the conductive base surface 6.

The triangular structure 4 and the rectangular structure 16 as the roof capacitor 10 are connected inductively with high impedance by at least one conductor strip 15 having an in particular narrow strip conductor width 14 of, for example, smaller than or equal to 7 mm for separating radio signals in the upper band, whereby the lower band monopole 2 is formed.

A vertical broadband monopole antenna for vehicles for two frequency bands, namely a lower band U for lower frequencies and an upper band O for higher frequencies, separated by a frequency gap and both disposed in the decimeter wavelength spectrum, is disclosed for transmitting and/or receiving using terrestrially broadcast, vertically polarized radio signals over a substantially horizontal conductive base surface 6 as a vehicle ground, having an antenna connection site 3 located in the monopole nadir, comprising the following features: The broadband monopole antenna is designed from a self-supporting electrically conductive structure which is oriented above and substantially perpendicular to the base surface 6. The electrically conductive structure comprises at the lower end of the broadband monopole antenna a triangular structure 4 standing on its apex and having a substantially horizontally oriented baseline, the apex of the triangular structure forming an antenna connection point 5 of the antenna connection site 3. The electrically conductive structure comprises a roof capacitor 10 substantially designed as a rectangular structure 16 adjacent to and below the upper end of the broadband monopole antenna 0. The triangular structure 4 and the rectangular structure 16 are connected inductively with high impedance by at least one conductor strip 15, 15a, 15b for separating radio signals in the upper band.

The electrically conductive structure can have at least two spaced apart conductor strips 15, whereby a frame structure 11 is formed comprising the triangular structure 4, the rectangular structure 16 and the conductor strip 15.

The conductor strip or strips 15, 15a, 15b can comprise meandering shapes 24 for a frequency-selective separation.

The internal angle 12 at the apex of the triangular structure 4 can amount to between 30 and 90 degrees, for instance.

The triangular structure 4 can also be designed by strip-shaped lamellas 20 arranged fan-like in the triangle plane and running together at the apex.

At least one annular satellite reception antenna 25, 25a, 25b which is arranged concentrically to the antenna connection site 3 can be present above the conductive base surface 6.

To improve the electromagnetic decoupling, the rectangular structure 16 can substantially be formed by strip-shaped roof lamellas 19, 19a, 19b which extend vertically and electrically conductively separate from one another, but contiguous at their upper end via a remaining strip 31.

The strip-shaped lamellas 30, 30a, 30b which run together in the apex can be angled out of the plane of the triangular structure 4 such that they extend substantially on the jacket surface of a cone standing on its apex and having a circular or elliptical cross-section.

The roof lamellas 19, 19a, 19b can be angled in opposite senses following one another in a manner such that they are arranged in V shape in a projection onto a plane extending transversely to the strip 31.

The lamellas 20a, 20b running together in the apex can be angled, in opposite senses following one another, out of the plane of the triangular structure 4 such that they are arranged in V shape in a projection onto a plane extending transversely to the triangular structure 4.

The broadband monopole antenna 0 can be arranged beneath a cover hood 32 and the at least one conductor strip 15, 15a, 15b can be passed at least in part and in particular as far as possible along the inner wall of the cover hood.

The electrically conductive structure can comprise electrically conductive sheet metal and only one, i.e. one single, self-supporting conductor strip 15 can be present.

The electrically conductive structure can be given by a metallic coating 33 on a circuit board whose contour substantially follows the outlines of the electrically conductive structure of the broadband monopole antenna 0.

The mirror image of the broadband monopole antenna 0 at the conductive base surface 6 can be replaced on its being dispensed with by a further broadband monopole antenna which is the same as it in a manner such that a dipole is present symmetrical to the plane of the conductive base surface 6 and a symmetrical antenna connection site of this dipole is formed between the antenna connection point 5 of the broadband monopole antenna 0 and the antenna connection point 5 of the further broadband monopole antenna which is mirrored correspondingly at the conductive base surface.

A coupling conductor 35 can be present which is connected at its upper end to the roof capacitor 10 and which is coupled at its lower end to the conductive base surface 6.

The invention will be explained in more detail in the following with reference to the embodiments. The associated Figures show in detail:

FIG. 1: frequency ranges in accordance with the LTE mobile communication standard as an example for two frequency bands in the decimeter wavelength spectrum which are separated by a frequency gap and have a frequency range between 698 and 960 MHz as a lower band U and a frequency range between 1460 MHz and 2700 MHz as an upper band O above a frequency gap;

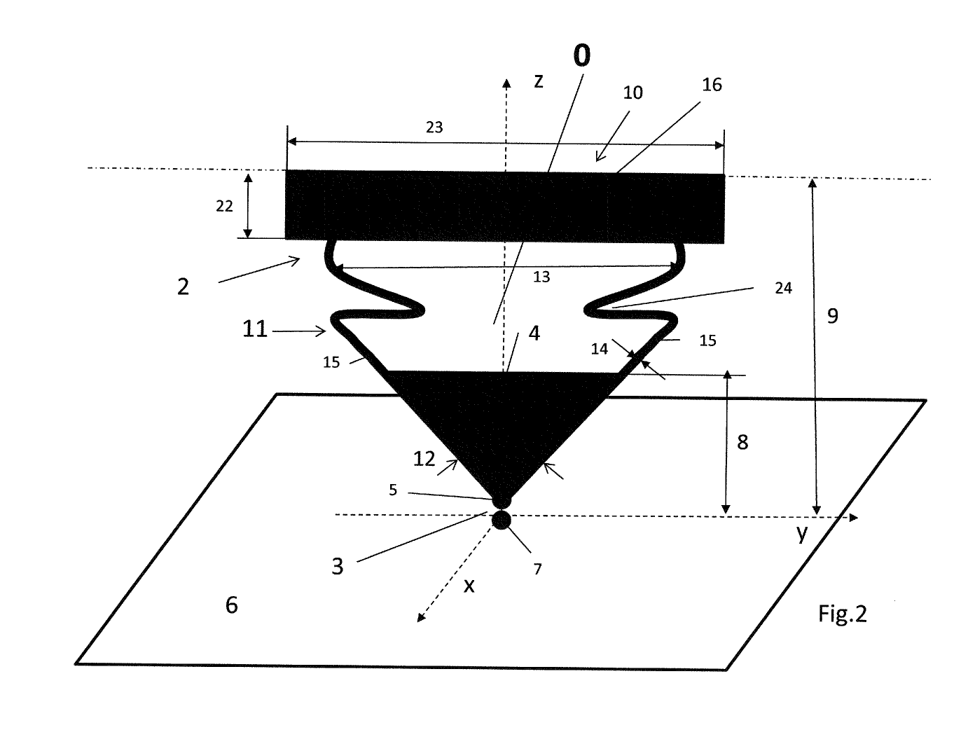

FIG. 2: a two-dimensional broadband monopole antenna 0 above the electrically conductive base surface 6 and the antenna connection site 3 formed at the nadir having a planar triangular structure 4 standing on its apex as an upper band monopole 1 and the roof capacitor 10 which are connected via two conductor strips 15 having a meandering shape 24 to the triangular structure 4 for forming the lower band monopole 2. The structure of the broadband monopole antenna 0 can be stamped or cut in full from sheet metal, for example;

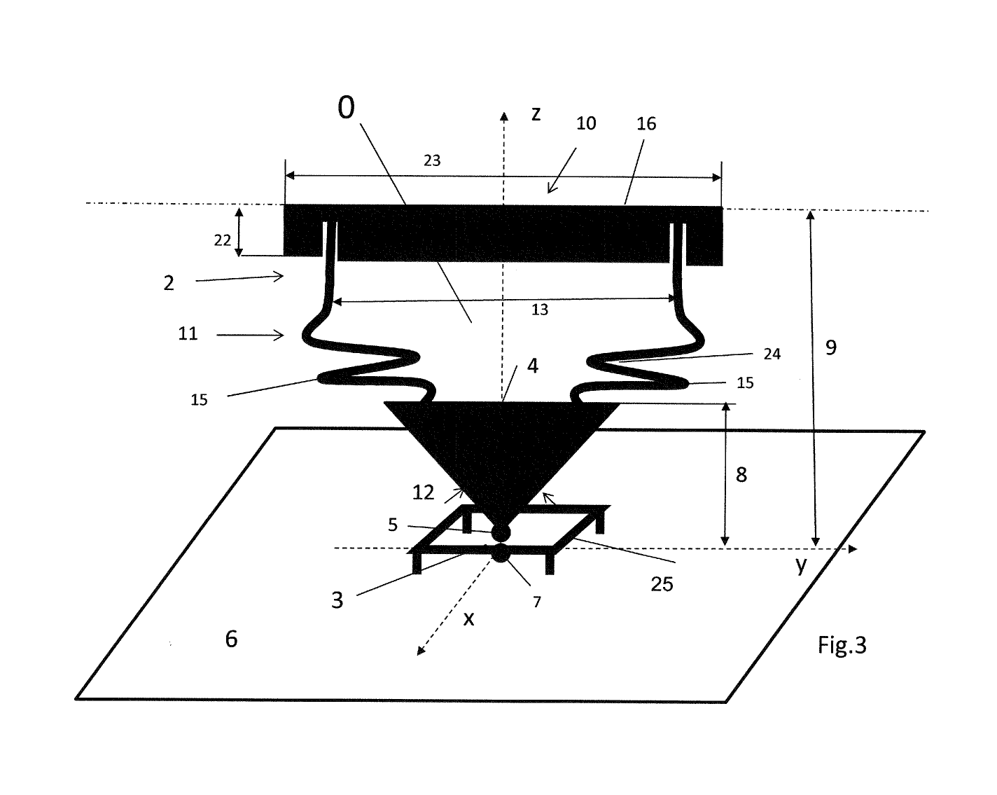

FIG. 3: a broadband monopole antenna 0 as in FIG. 2, combined with an annular satellite reception antenna 25 designed concentric to the apex of the planar triangular structure 4. To further increase the inductive effect of the conductor strips 15, further meandering shapes 24 are formed by way of example;

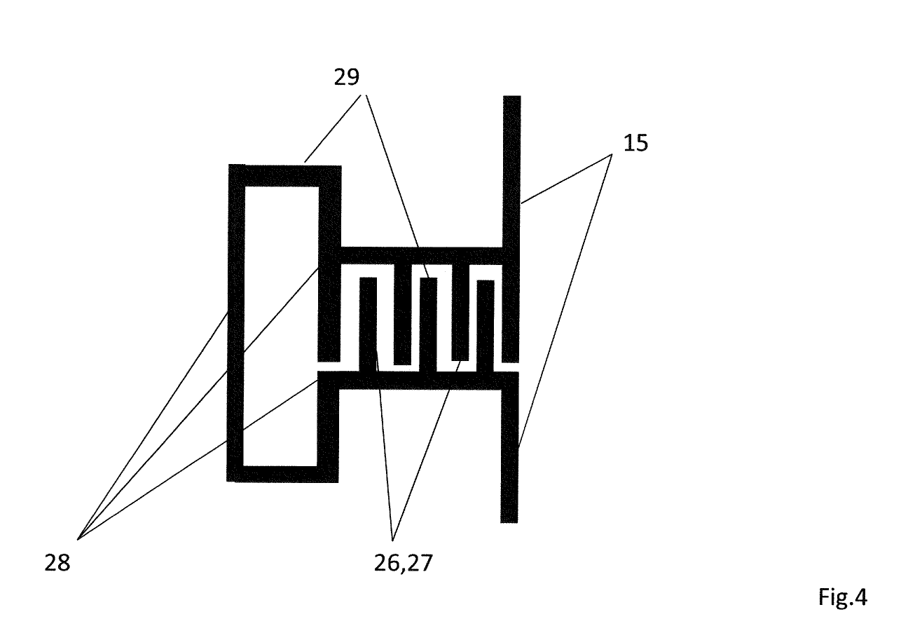

FIG. 4: an example of a structure which can be manufactured from conductive film or sheet metal by stamping or cutting and has the frequency behavior of an electrical parallel oscillating circuit 29 in the conductor strip 15 for designing the frequency-selective separation of the lower band monopole 2 from the upper band monopole 1. The parallel oscillating circuit 29 is formed by an interdigital structure 26 as a parallel capacitance 27 and the conductor loop as a parallel inductance 28;

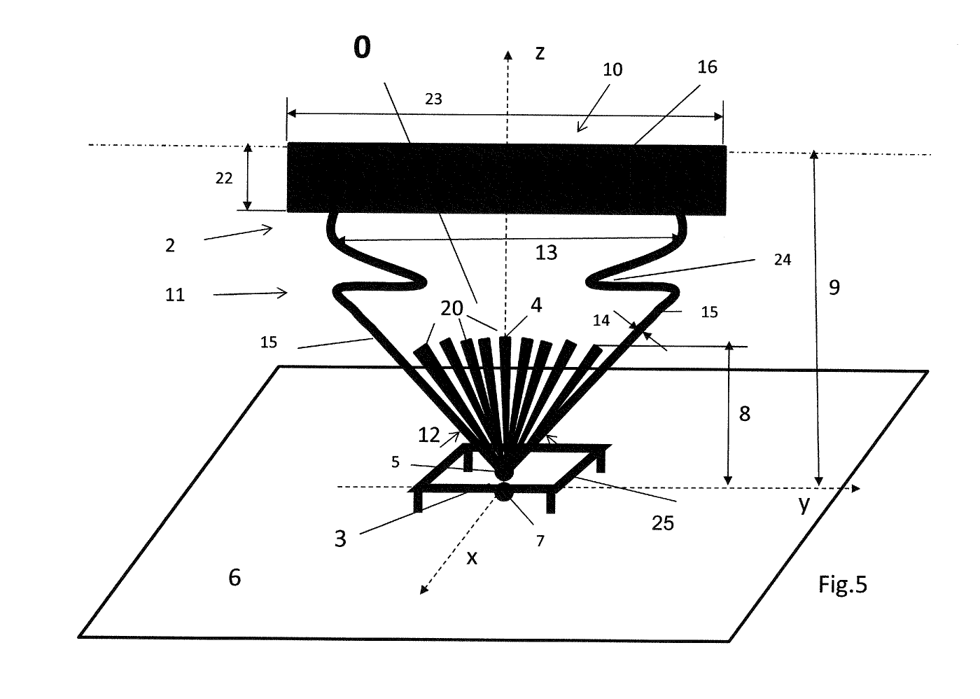

FIG. 5: a two-dimensional broadband monopole antenna 0 as in FIGS. 2 and 3, with the planar triangular structure 4 of the upper band monopole 1 being designed by strip-shaped lamellas 20 arranged fan-like in the triangle plane and running together at the lower triangle apex. The lamellas 20 conductively connected to one another only via the triangle apex effect the electromagnetic decoupling of the upper band monopole 1 from the annular satellite reception antenna 25;

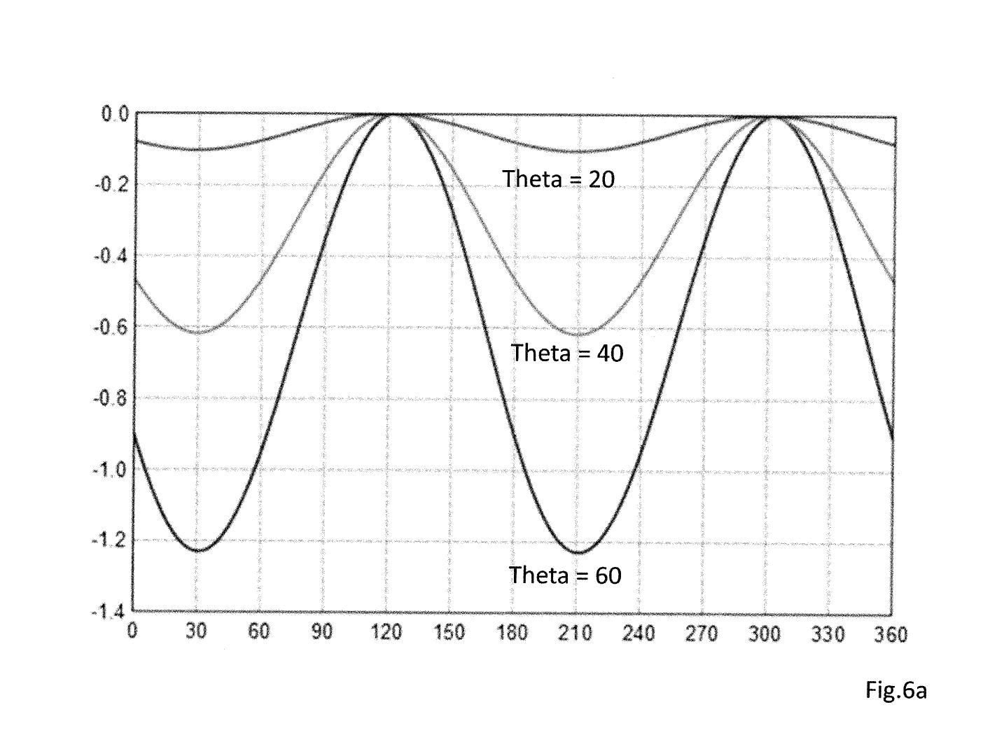

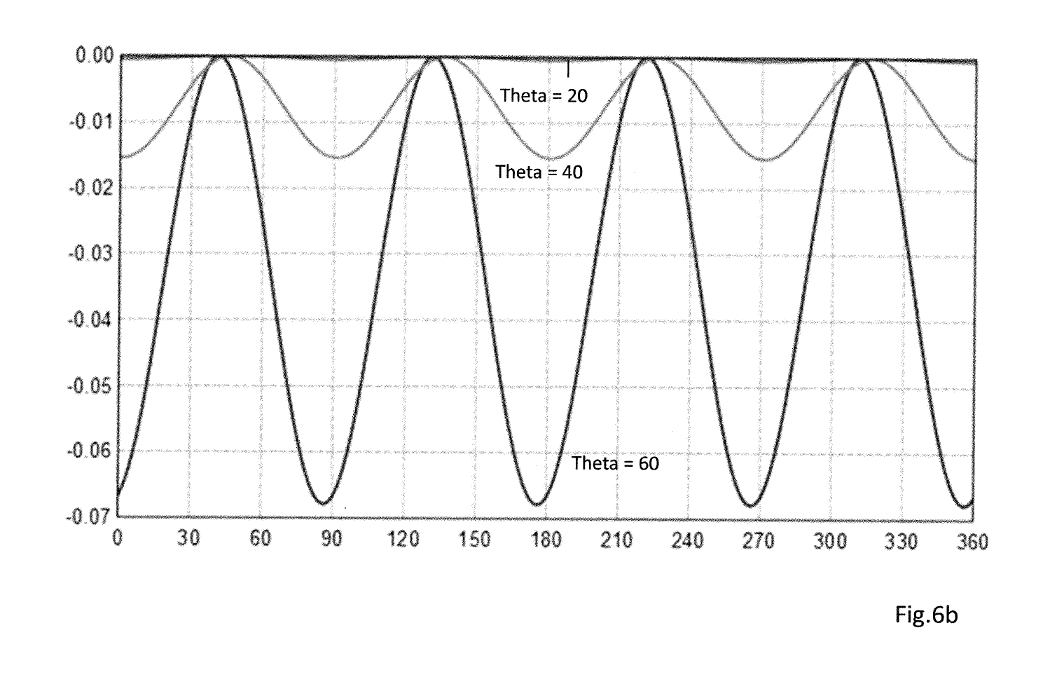

FIG. 6a: fluctuation of the antenna gain over the azimuth angle phi of the satellite reception antenna 25 in dBi on a presence of the planar triangular structure 4 as a closed electrically conductive area;

FIG. 6b: as in FIG. 6a, but with a triangular structure 4 designed by strip-shaped lamellas 20 extending fan-like. The azimuthal fluctuations are each shown for the zenith angle theta (angle toward the vertical, i.e. z axis) 20°, 40° and 60°;

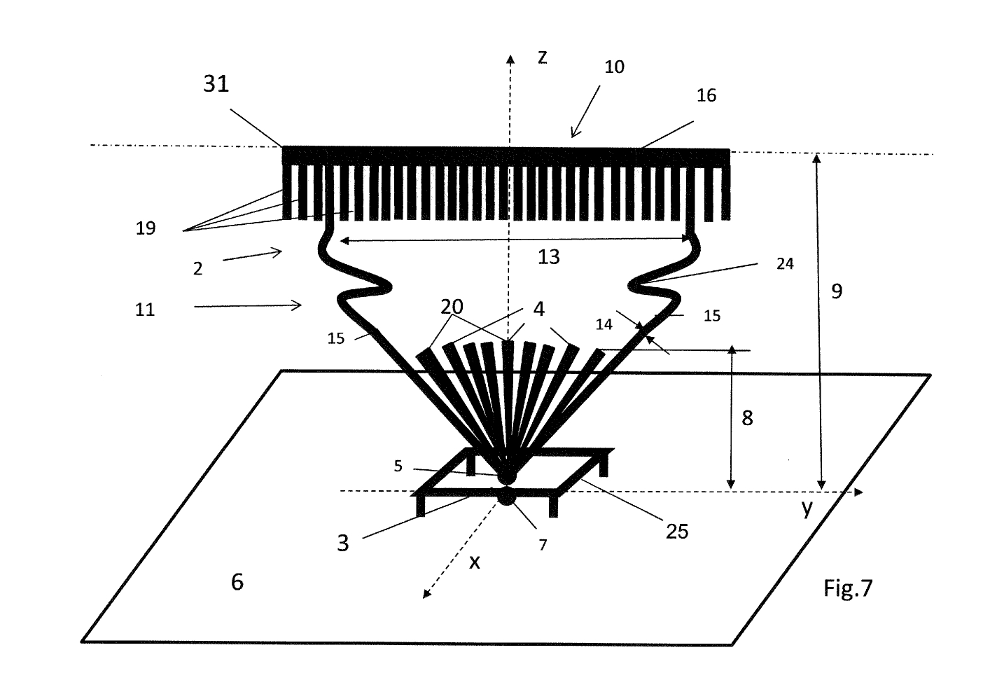

FIG. 7: a monopole antenna as in FIG. 4 with an annular satellite reception antenna 25, but wherein, to improve the electromagnetic decoupling between it and the lower band monopole 2, the planar rectangular structure 16 forming the roof capacitor 10 is formed by strip-shaped roof lamellas 19 extending vertically and separate from one another, but contiguous at their upper end above a remaining strip 31;

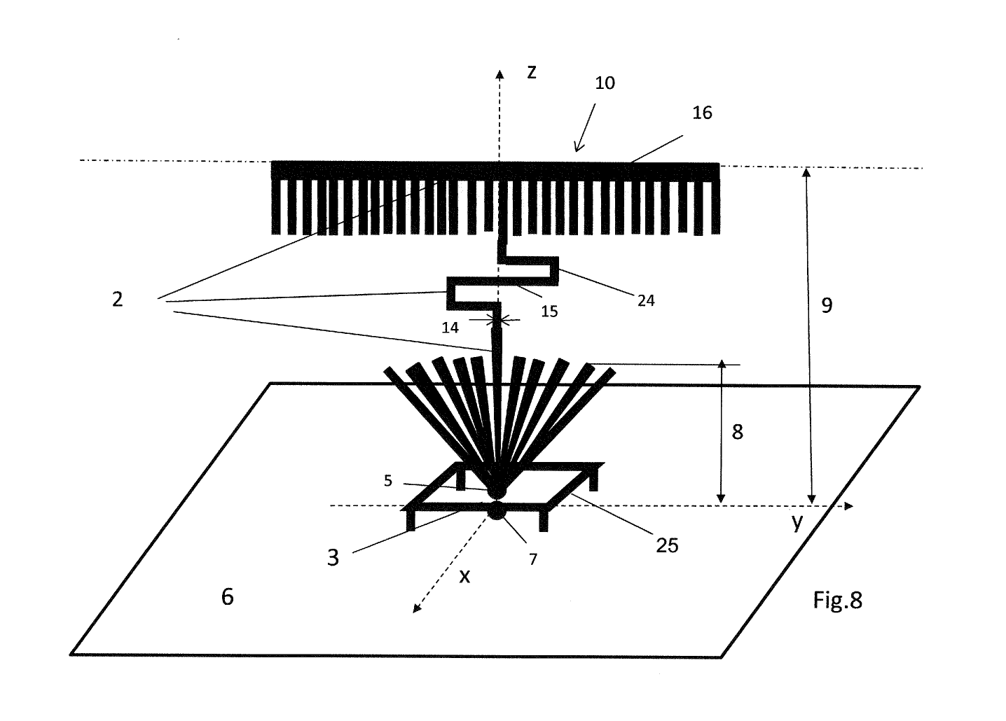

FIG. 8: a monopole antenna as in FIG. 7, but having only one self-supporting conductor strip 15 with a larger sheet metal thickness in favor of special mechanical stiffness and correspondingly with a plurality of meandering shapes 24 to achieve the required inherent inductance of the conductor strip 15;

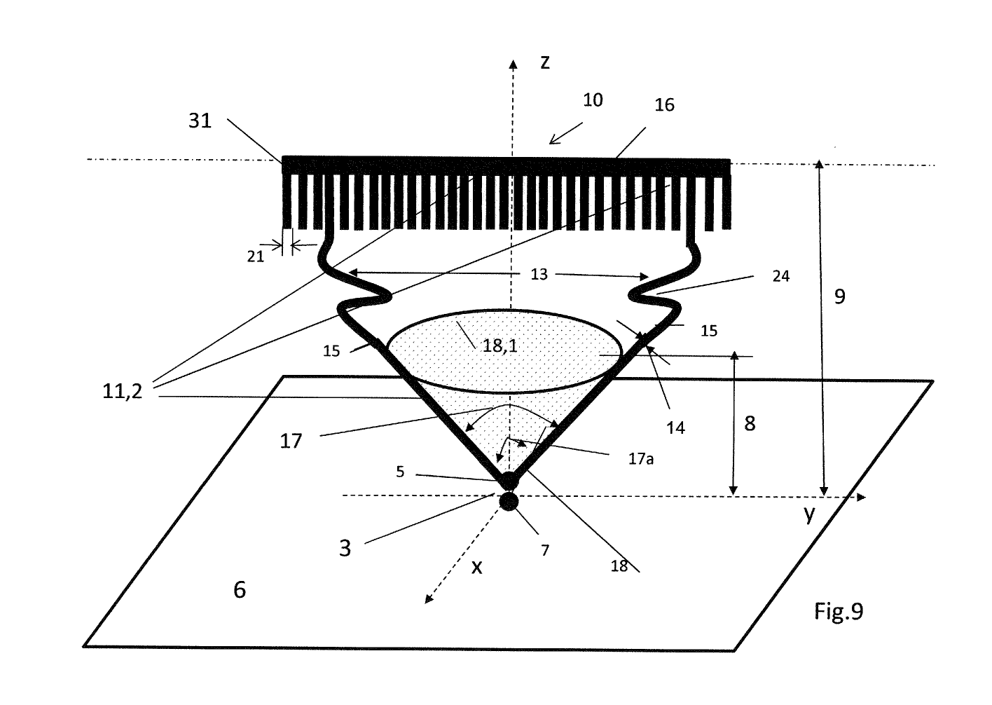

FIG. 9: a monopole antenna as in FIG. 7, but having an upper band monopole 1 which is conical and which stands on its apex instead of the planar triangular structure in order to improve the bandwidth in the upper band. The electrically conductive cone jacket is indicated by dots;

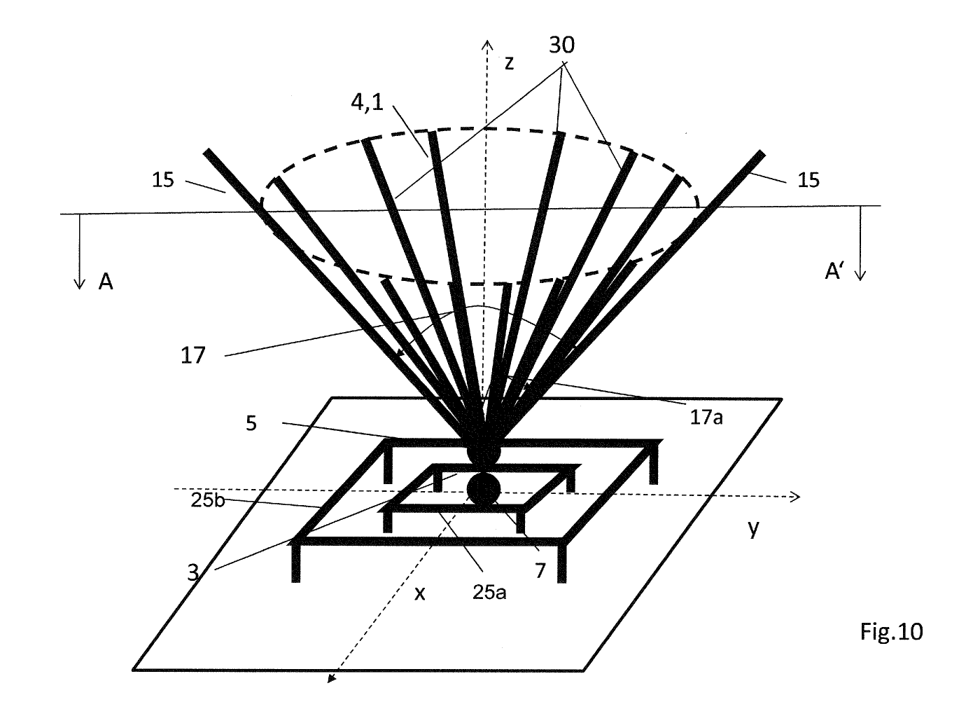

FIG. 10: an upper band monopole 1 as in FIGS. 5, 7 and 8, but wherein the strip-shaped lamellas 30 of the upper band monopole 1 running together fan-like in the lower triangle apex are angled out of the plane of the planar triangular structure 4 in a manner such that they extend approximately like the jacket lines of a cone standing on its apex in accordance with FIG. 8 and having a circular or elliptical cross-section;

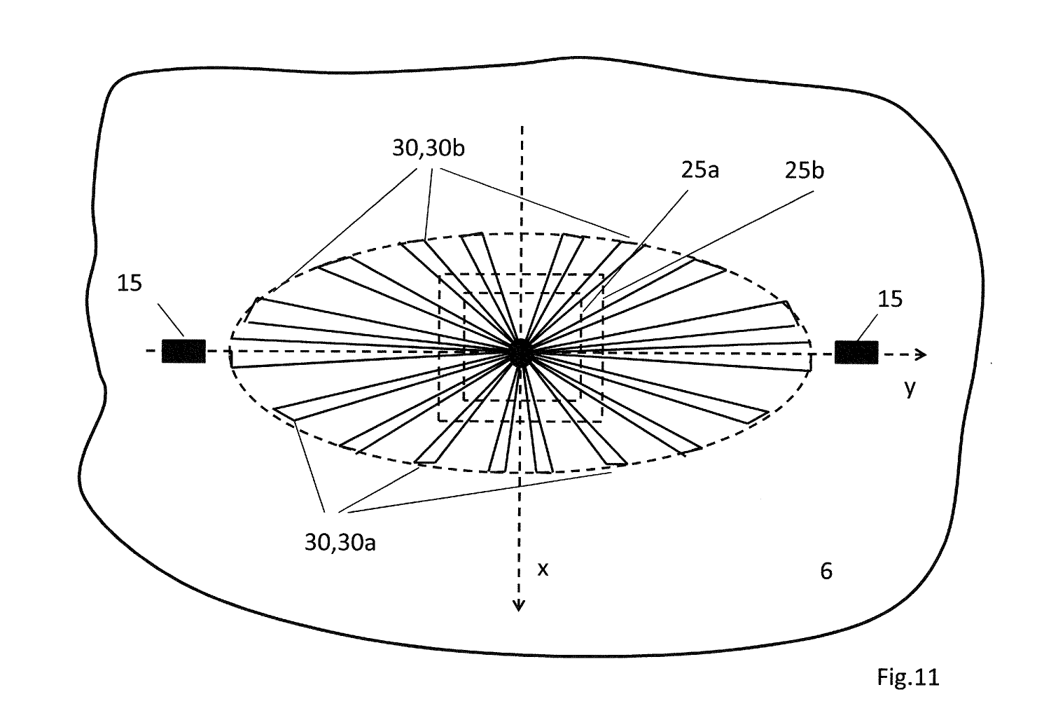

FIG. 11: a plan view of an antenna in accordance with the line A-A′ indicated in FIG. 10 for clarifying the extent of the strip-shaped lamellas 30, 30a, 30b extending fan-like. The annular satellite reception antennas 25a and 25b are indicated by dashed lines;

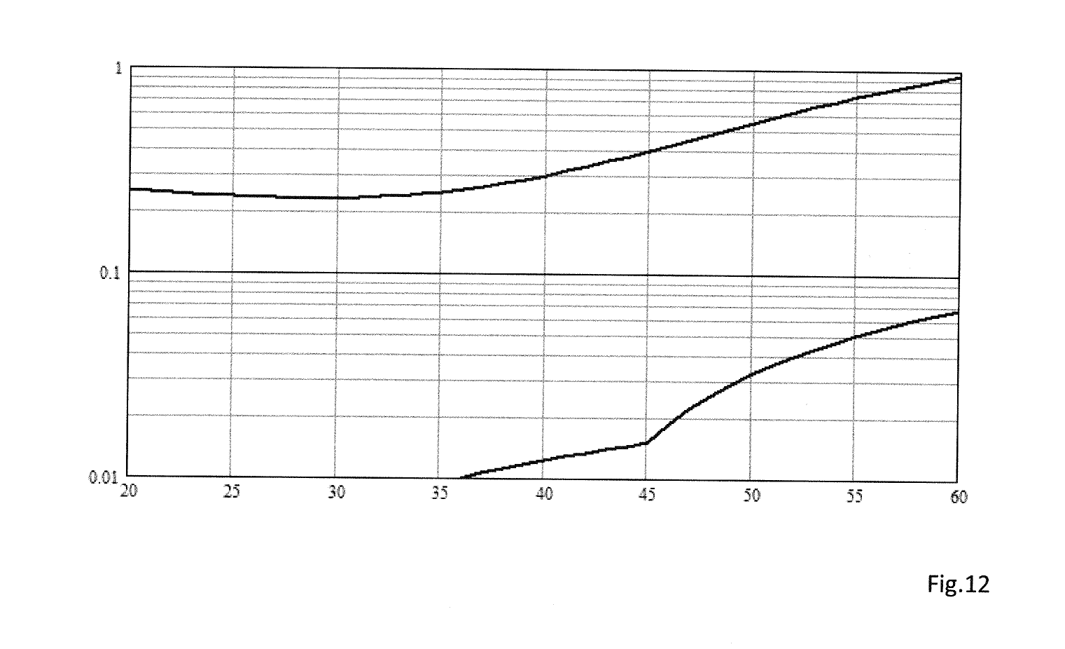

FIG. 12: a maximum value of the azimuthal fluctuation of the antenna gain in dBi with a closed electrically conductive cone jacket and with a cone jacket formed from strip-shaped lamellas 20 in dependence on the zenith angle (angle toward the z axis);

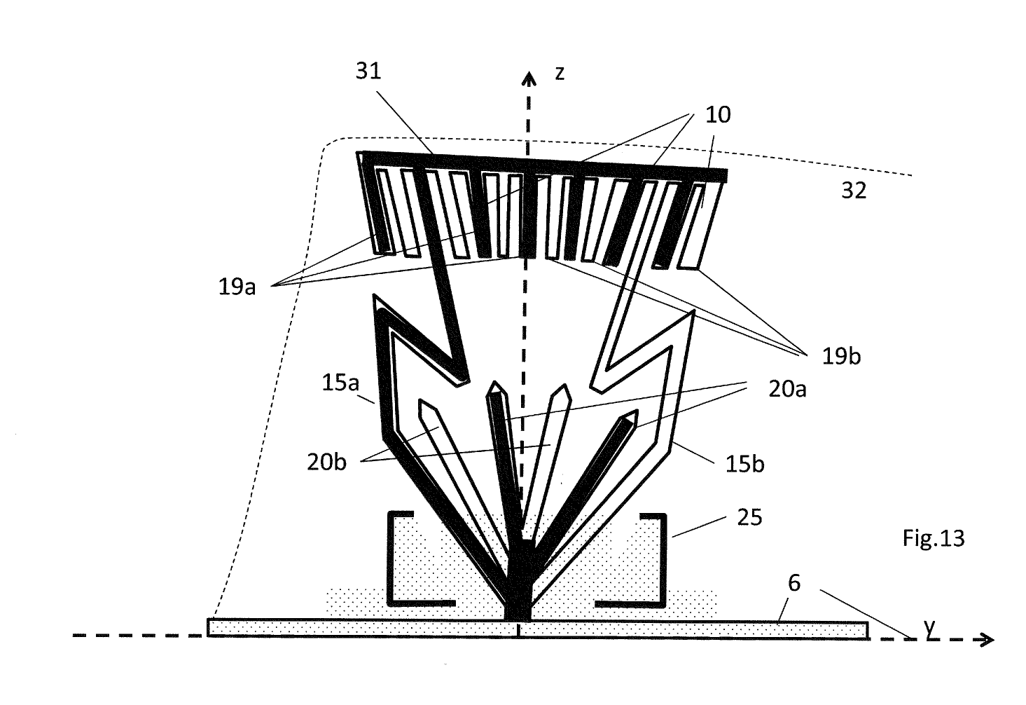

FIG. 13: installation situation of a broadband monopole antenna beneath a cover hood 32 looking at the antenna transversely to the direction of travel (y direction) together with an annular satellite reception antenna 25. The conductor parts highlighted in black and marked by a) are the conductor strips 15a, the roof lamellas 19a and the strip-shaped lamellas 20a and are angled out of the y-z plane of the planar triangular structure 4 in the direction of the x axis and the conductor strips 15b, the roof lamellas 19b and the strip-shaped lamellas 20b are accordingly angled in the direction of the negative x axis so that a spatial antenna structure is formed;

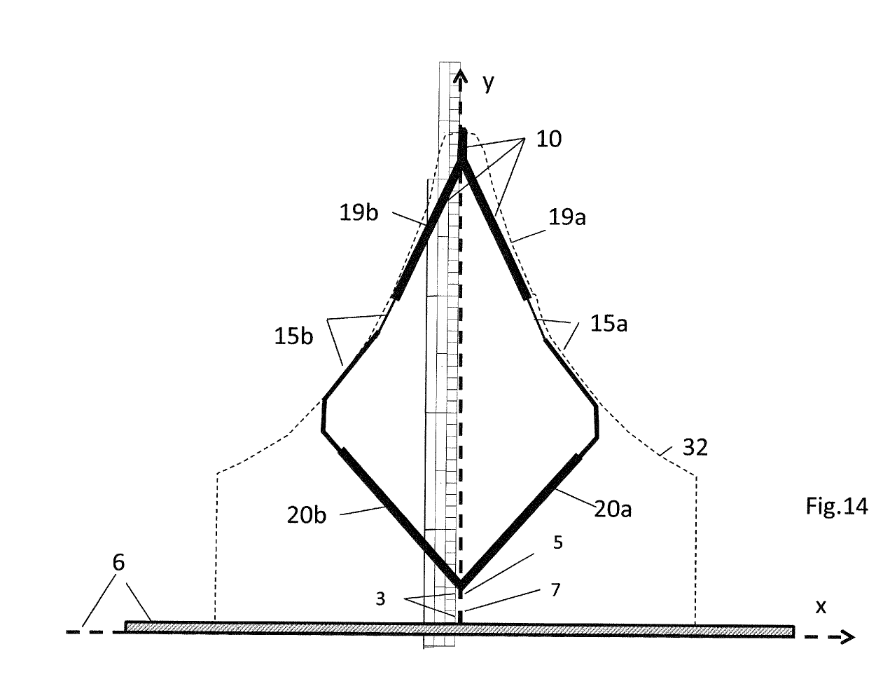

FIG. 14 installation situation in accordance with FIG. 13, but looking at the arrangement in the direction of travel;

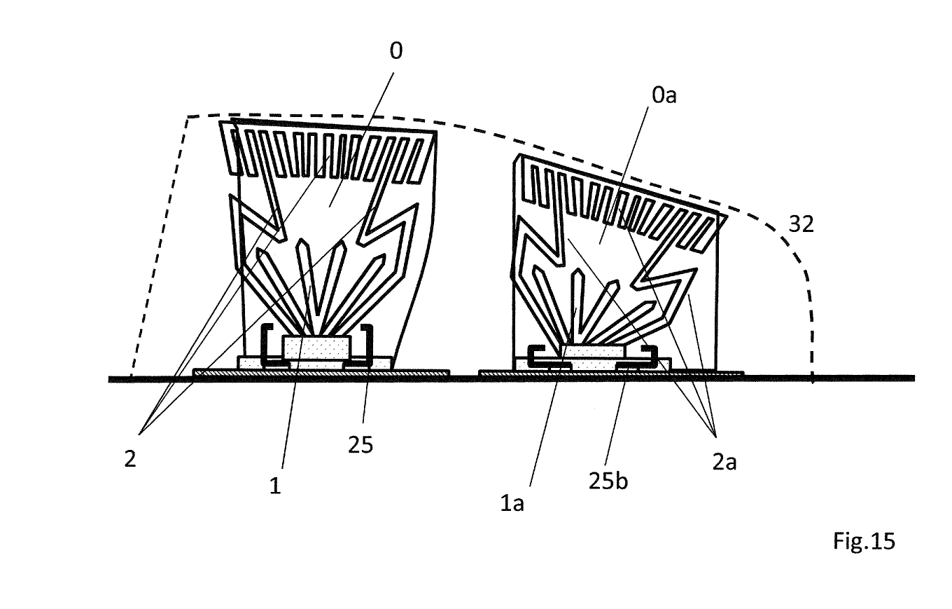

FIG. 15: installation situation of two broadband monopole antennas 0 and 0a in accordance with FIG. 14 behind one another in the direction of travel beneath a common cover hood 32 and comprising an upper band monopole 1 and 1a, respectively, and a lower band monopole 2 and 2a respectively each having an annular satellite reception antenna 25a and 25b respectively at the nadir of the broadband monopole antenna 0 and 0a respectively;

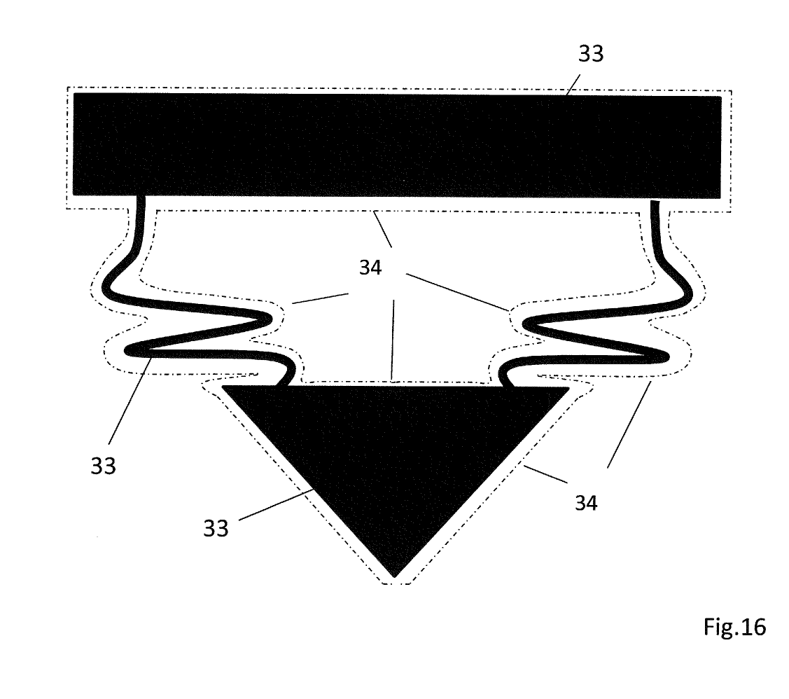

FIG. 16: a broadband monopole antenna 0 as in FIG. 2, wherein the electrically conductive structure 33 is given by the metallic coating of a circuit board and the circuit board with its coating is designed approximately in accordance with the outlines of the broadband monopole antenna 0, represented by the sectional lines of the dielectric plate 34; and

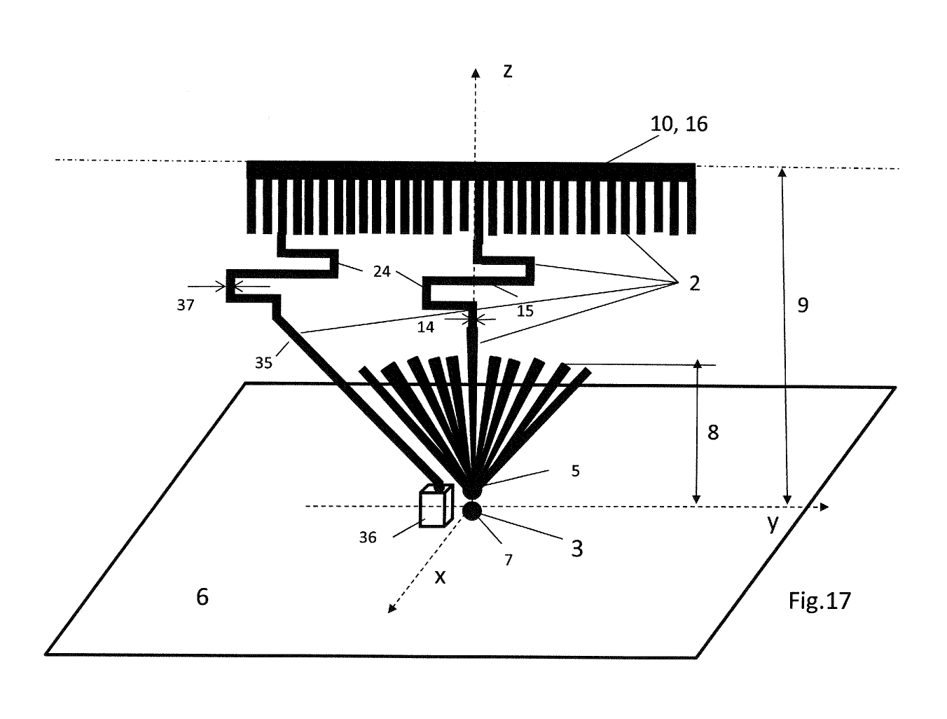

FIG. 17: a broadband monopole antenna 0 as in FIGS. 2, 3, 5, 7, 8, 9, 10, but having a coupling conductor 35 connected to the roof capacitor 10 as a supplement to the lower band monopole 2 in order to improve the impedance matching at the antenna connection site 3 at the lower frequency end of the lower band of the broadband monopole antenna 0. The coupling of the coupling conductor 35 at its lower end to the conductive base surface 6 is selectively designed by a galvanic connection or via a dipolar, low-loss coupling network 36.

A special advantage of a broadband monopole antenna 0 in accordance with the invention is the property that the impedance which can be measured at the antenna connection site 3 can be designed largely problem free in a broadband manner in the proximity of the standardized impedance of Z0=50 ohms prescribed for antenna systems for vehicles. The economic advantage further results from this that a matching network between the antenna connection site 3 at the nadir of the broadband monopole antenna and the continuative circuit can mostly be dispensed with or can at least be designed as particularly low effort.

A broadband monopole antenna 0 in accordance with the invention will be explained by way of example in the following for the two frequency ranges separated by a frequency gap in accordance with the lower band U and the upper band O shown in FIG. 1. The broadband monopole antenna in its flat-designed basic configuration in FIG. 2 is substantially formed from a lower band monopole 2 for covering the lower band with an antenna height 9 required for this purpose in combination with an upper band monopole 1 with the upper band monopole height 8 with a common antenna connection site 3. To avoid too great an effective antenna height 9 in the frequency range of the upper band, the lower band monopole 2 is designed from conductor strips 15 of inductively high impedance in the frequency range of the upper band and having a narrow strip conductor width 14 in connection with an roof capacitor 10. The latter is substantially designed as a planar rectangular structure 16 and with a large horizontal extent 23 in comparison with the vertical extent 22.

To satisfy the demand for a manner of manufacture which is as simple and as economic as possible, the monopole antenna in accordance with the invention is designed, for example, from an electrically conductive film 33 (FIG. 16) as a contiguous, electrically conductive structure extending in a plane extended substantially perpendicular to the conductive base surface 6. In this respect, it has been found as a particularly advantageous embodiment of the invention to use electrically conductive sheet metal or a self-supporting electrically conductive film for the self-supporting electrically conductive structure, which is in particular formed in one piece, from which a mechanically self-supporting structure for the total broadband monopole antenna 0 can be manufactured. This structure can by way of example be manufactured by a stamping process or by a controlled cutting process, for example by controlled laser cutting. In this respect, the manufacture of a stamping tool will prove to be economically advantageous with particularly large volumes because the monopole antenna can be reproduced extremely inexpensively by automated stamping processes. On the other hand, with smaller volumes, laser cutting controlled by computer can prove to be more economic. The manufacture of the broadband monopole antenna 0 from metal sheet provides the particular advantage of metallic stiffness which is of particular importance for the use as a vehicle antenna. The negligible wind resistance can be named as a special advantage of this flat-designed structure when it is designed in an advantageous manner as extending in a plane whose normal is oriented perpendicular to the direction of travel of the vehicle.

The electrically conductive structure can furthermore be selected in an advantageous embodiment of the invention by the metallic coating of a dielectric board, that is of a circuit board. It must, however, be taken into account in this respect that a material for the circuit board which can be considered for economic reasons is subject to losses in the decimeter wavelength spectrum so that provision can be made in accordance with the invention to print the structure of the broadband monopole antenna 0 onto the circuit board in a manner known per se, but to cut it approximately in accordance with the outlines of the broadband monopole antenna 0 with a slight overhang in order to keep the extent of electrical field lines in the dielectric board suffering from loss as small as possible. The cutting of the dielectric board along the chain-dotted lines 34 is shown in FIG. 16. This type of representation is in particular advantageous with a complicated geometrical structure of the broadband monopole antenna 0 because the lines 34 can be designed less finely following the geometrical structure and therefore require a less complex and/or expensive stamping tool.

With a broadband monopole antenna 0 of this type, the voltage standing wave ratio (VSWR)<3 is required in the above-named lower band, for example, for the matching of antenna systems to the standardized impedance of Z0=50 ohms prescribed for vehicles. This value can generally already be achieved with an antenna height 9 of 6 cm in an antenna in accordance with the invention in its complete design at the antenna connection site 3. The properties of the lower band monopole 2 are substantially determined by its antenna height 9 and by the size of the planar roof capacitor 10 whose horizontal extent 23 is substantially larger at approximately 6 cm, that is it is designed approximately at least three times larger, than the vertical extent. A substantially larger vertical extent 22 admittedly increases the capacitance value of the roof capacitor 10, but reduces the effective height of the lower band monopole 2 which, in contrast to the capacitance value, enters into the formation of the frequency bandwidth of the lower band monopole 2 in squared form.

The formation of the upper band monopole 1 is substantially given by the planar triangular structure 4 provided that the inductive effect of the conductor strips 15 having a narrow strip conductor width 14 is sufficiently large for the separation of radio signals in the upper band from the roof capacitor 10. This is given as a rule with a strip conductor width of smaller than or equal to 7 mm. Provision can be made in accordance with the invention to provide the conductor strips 15 with meandering shapes 24 to increase this separating effect. The functional division of the broadband monopole antenna 0 into the lower band monopole 2 and the upper band monopole 1 is naturally not be seen too strictly. The transition between the effects is rather flowing and the division is to be understood as a description for the primary effects in the two frequency ranges. The mode of operation of the upper band monopole 1 located above the conductive base surface 6 is substantially given by the design of the planar triangular structure 4. In the interest of a particularly broadband behavior, in this embodiment a planar triangular structure 4 is provided standing on its apex and having a triangle opening angle 12 whose apex is connected to the antenna connection point 5. The antenna connection site 3 for the broadband monopole antenna 0 is formed by said antenna connection point together with the ground connection point 7. The height of the baseline of the planar triangular structure 4 above the conductive base surface 6 substantially forms the effective upper band monopole height 8 by which the frequency behavior of the upper band monopole 1 is substantially determined. For reasons of the vertical radiation diagram for the communication with terrestrial transmission and reception stations, the upper band monopole height 8 at the upper frequency limit of the upper band should not be larger than approximately ⅓ of the free wavelength at this frequency. Values between 30 and 90 degrees have proven favorable as the triangular opening angle 12. The triangular structure of broadband effect thereby arising makes it possible, for example, to satisfy the frequently made demand on the impedance matching at the nadir at a value of VSWR <2.5 in the frequency range of the upper band.

Corresponding to the objective with respect to the required mechanical stability for holding the roof capacitor 10 by narrow conductor strips 15, provision is made in accordance with the invention to design them as mechanically sufficiently stiff. In a particularly advantageous embodiment of a broadband monopole antenna 0 in accordance with the invention designed from stamped or cut sheet metal, a frame structure 11 is designed to achieve a special stiffness. In this respect, the frame structure 11, as shown in FIGS. 2 and 3, is formed from two narrow conductor strips 15 which are conducted at a sufficient spacing 13 from one another, from the baseline of the planar triangular structure 4 and from the planar triangular structure 16 of the roof capacitor 10.

In a further advantageous embodiment of the invention, the electrically conductive structure comprises a material of particular stiffness, for example thin sheet metal. On a use of such materials, the broadband monopole antenna 0 can be designed with only one conductor strip 15, as shown in FIG. 8. In the interest of mechanical stability, however, a larger strip conductor width 14 must then be provided for it. As a rule a plurality of meandering shapes 24 have proven to be necessary to design a sufficiently large inductive effect of the conductor strip 15.

Provision is made in an advantageous embodiment of the invention for the fine tuning of the cooperation between the lower band monopole 2 and the upper band monopole 1 to introduce a switch element having the mode of operation of a parallel oscillating circuit 28 into the conductor strip 15. This parallel oscillating circuit serves for supporting the frequency-selective separation of the lower band monopole 2 from signals in the upper band. In accordance with the invention, the parallel oscillating circuit 28, as shown in FIG. 4 respectively comprises a parallel capacitance 27 designed as an interdigital structure 26 and a parallel inductance 28 designed as a strip conductor. This switching element, stamped or cut from sheet metal by way of example, can also be included via the conductor strips 15 into the design of the mechanically self-supporting broadband monopole antenna 0.

For the further improvement of the frequency bandwidth of the upper band monopole 1, a three-dimensional structure is provided for it in an advantageous embodiment of the invention, the three-dimensional structure being formed from the two-dimensional structure in a manner such that an approximately conical structure is aimed for instead of the planar triangular structure 4. The shape of such a monopole is indicated in FIG. 9 with reference to the conical monopole 18 having electrically conductive jacket surfaces. In this respect, the economically manufacturing capability from stamped or cut sheet metal is to be maintained. Provision is therefore made in accordance with the invention to design the planar triangular structure 4 by strip-shaped lamellas 20 running together fan-like in the lower triangle apex, as shown in FIG. 5. By angling the lamellas 20 such that they lie on the jacket surface of a cone standing on its apex, they become conical lamellas 30 and the conical monopole 18 in FIG. 9 is emulated with respect to its effect as an upper band monopole 1. This is shown in detail in FIG. 10 and equally becomes visible as a plan view in accordance with the line indication A-A′ in FIG. 11. In FIG. 11, the cone cross-section indicated in FIG. 10 is elliptical and thus the cone opening angle 17a (FIG. 10) is selected smaller in the x direction due to the demands with respect to the aerodynamic properties of the antenna than the cone opening angle 17 in the direction of travel of the vehicle (y direction).

Due to the tight construction spaces, the main demand exists with vehicle antennas for small size and in particular also to minimize the base outline of the antenna. In this respect, the deformation of the radiation diagram of the satellite antenna is in particular problematic for satellite radio surfaces and antennas for other radio services in tight space due to the radiation coupling between the antennas. This problem is also present when—as in FIGS. 3, 5, 7, 8, 10, 11 and 15—at least one annular satellite reception antenna 25, 25a, 25b arranged concentric to the antenna connection site 3 of a broadband monopole antenna 0 is present. There is the strict demand with respect to this, e.g. in accordance with the standard for satellite broadcasting SDARS, in the zenith angular range (angle with respect to the z axis) e.g. between 0 and 60 degrees, for an antenna gain which amounts in dependence on the operator for circular polarization of a constant e.g. 2 dBi or e.g. 3 dBi respectively with an azimuthal fluctuation of less than 0.5 dB. An annular satellite reception antenna 25 arranged concentric to the antenna connection site 3 of a broadband monopole antenna 0 is present in FIG. 3. On a configuration of the upper band monopole 1 as a closed planar structure, the azimuthal fluctuations of the antenna gain of the satellite reception antenna 25 shown in FIG. 6a result at approximately 2.3 GHz. At a zenith angle theta of 40 degrees, the gain fluctuation at 0.6 dBi is already above the tolerance value and is outside tolerance at 1.2 dBi at 60 degrees. In this connection, the design of the triangular structure 4 from lamellas 20 running together fan-like at the apex, as in FIG. 5, is more favorable than a closed planar triangular structure 4 in accordance with FIG. 3. This advantage of the small influencing of the radiation properties of the satellite reception antenna 25 is particularly pronounced on the design of the upper band monopole 1 from conical lamellas 30. This can be seen by way of example from the azimuthal fluctuations of the antenna gain shown at different zenith angles in FIG. 6b which has an experimentally practically not detectable fluctuation of 0.07 dB even at a zenith angle of 60 degrees. The difference between the influences of the upper band monopole 1 in the form of a closed electrically conductive cone jacket and of a jacket of conical lamellas 30 on the azimuthal fluctuation of the antenna gain of the satellite reception antenna 25 in dependence on the zenith angle in degrees can furthermore also be seen impressively from FIG. 12. This is shown by the azimuthal gain fluctuation in dB for a closed conductive cone jacket (upper graph) and a cone jacket of lamellas (lower graph). By avoiding ring currents which are caused by the currents on the satellite antenna 25 on a conductive cone jacket by radiation coupling of the two antennas and when designing the cone jacket from conical lamellas 30 of the upper band monopole 1, the latter is without any influence on the radiation properties of the satellite reception antenna 25.

In order also to improve the electromagnetic decoupling between the satellite reception antenna 2 and the planar rectangular structure 16 forming the roof capacitor 10 of the lower band monopole 2, it can be designed in accordance with the invention substantially by strip-shaped roof lamellas 19 which extend vertically electrically conductively and separate from one another, but contiguous at their upper end via a remaining strip 31, as shown in FIGS. 7, 8 and 9. In this respect, their strip width 21 should not be larger than ⅛ of the free wavelength of the highest frequency in the upper band.

Provision is frequently made to accommodate a broadband monopole antenna 0 beneath a cover hood 32 made from plastic material, as is shown in FIG. 13 with a view transversely to the direction of travel (x direction) and in FIG. 14 with a view in the direction of travel (y direction). In this respect, the extent of the cover hood 32 transversely to the direction of travel visible in FIG. 14 makes possible the option of a further spatial design of the originally flat-produced broadband monopole antenna 0 with the advantages of the increasing of the bandwidths of both monopoles 1 and 2. This is expressed by a better designability of the antenna impedance with respect to the VSWR value at the antenna connection site 3. The possibility is thereby given of largely being able to dispense with a matching network.

To design the spatiality of the lower band monopole 2, the strip-shaped roof lamellas 19 of the roof capacitor 10 contiguous at their upper end via a remaining strip can be angled in accordance with the invention in a manner such that they are arranged in V shape in projection onto a plane disposed transversely to the direction of travel. For this purpose, the roof lamellas 19a marked in solid black are deflected in the x direction and the roof lamellas 19b marked in solid white are deflected in a negative x direction in a mutually alternating manner in opposite senses so that the V-shaped structure visible in projection is FIG. 13 is given. The capacitance value of the roof capacitor 10 becomes larger due to the lateral deflection transversely to the direction of travel or to the plane of the triangular structure or of the step 31. This results in an increase in the bandwidth of the lower band monopole 2 and facilitates the observation of the condition for impedance matching in the VSWR value to be observed.

Analogously to the design of a cone having an elliptical cross-section by a corresponding deflection of the lamellas 20, 20a, 20b of the upper band monopole 1 in FIG. 11, in a further advantageous embodiment of the invention, the lamellas 20, 20a, 20b can be angled approximately following the inner boundary of the cover hood 32. This means that the strip-shaped lamellas 20, 20a, 20b of the upper band monopole 1 running together in the bottom triangle apex are bent out of the plane of the planar triangular structure 4 following one another in a manner such that they are arranged approximately in V shape in the projection onto a plan disposed transversely to the direction of travel. In the same way as described above for the roof lamellas 19, 19a, 19b, the lamellas 20 are angled in a manner such that the lamellas 20a marked in solid black in FIG. 13 are deflected in the x direction and the lamellas 20b marked in solid wide are deflected in the negative y direction in opposite senses so that the V-shaped structure visible in projection in FIG. 14 is present. This measure here also serves for increasing the frequency bandwidth of the upper band monopole 1 with the associated advantage in the realization of the impedance matching at the antenna nadir. It has proven advantageous in the realization of antennas such as are shown in FIGS. 13, 14 and 15 also to design the at least two conductor strips 15, 15a, 15b spatially in a manner such that they e.g. take up the horizontal extent available to them transversely to the direction of travel within the cover hood 32 e.g. by angling at half the antenna height 9 by approximately 45° or −45° respectively with respect to the y axis. The conductor strips can therefore be shaped such that they extend as far as possible along the inner wall of the cover hood 32.

It must generally be observed that the spatial design in accordance with the invention starting from the described two-dimensional design of the monopole antenna 0 in accordance with the invention is additionally advantageous with respect to the problem of impedance matching over large frequency ranges. The special advantage is thus associated with the present invention that this spatially designed antenna can be stamped or cut from a flat, electrically conductive structure (sheet metal or film) and can be designed, as described above, by a simple subsequent bending.

It is also possible to apply two broadband monopole antennas 0 and 0a in accordance with the invention beneath a cover hood 32 behind one another in the direction of travel, as in FIG. 15. It has been found in this respect that the annular satellite antennas 25 do not undergo any interfering influencing of their radiation properties at the nadir of the one broadband monopole antenna 0 by the presence of the other broadband monopole antenna 0a. This applies conversely with respect to the effect of the broadband monopole antenna 0 on the satellite antennas 25a at the nadir of the one broadband monopole antenna 0a.

In a further advantageous use of a broadband monopole antenna 0 in accordance with the invention, this is supplemented by a further broadband monopole antenna the same as it to form a dipole in a manner known per se. In this respect, the mirror image of the broadband monopole antenna 0 at the conductive base surface 6 is replaced, while being dispensed with, by this further broadband monopole antenna in a manner such that a dipole symmetrical to the plane of the conductive base surface 6 is given. In this respect, the symmetrical antenna connection site of this dipole is formed between the antenna connection point 5 of the broadband monopole antenna 0 and the antenna connection point 5—corresponding to it—mirrored at the conductive base surface 6.

In a further advantageous application of a broadband monopole antenna 0 in accordance with the invention, a coupling conductor 35 is present which is connected at its upper end to the roof capacitor 10, which extends toward the conductive base surface 6, in order to assist the impedance matching at the lower frequency end of the lower band, and which is coupled at its lower end to the conductive base surface 6. This coupling conductor 35 is shown in FIG. 17 and complements the lower band monopole 2 in a manner such that it is possible to improve the impedance matching at the antenna connection site 3 to the lower frequency end of the lower band. By designing the coupling conductor width 37 or by a partly meandering shape 24 of the coupling conductor 35, its inductive effect can be suitably set to the demands for the impedance matching (e.g. VSWR <3). With a sufficiently inductively high-impedance design of the coupling conductor 3, the latter is not effective in the frequency range of the upper band monopole 1 in a manner such that its radiation properties are not thereby impaired. It is in many cases advantageous in this respect to establish the coupling of the coupling conductor 35 to the conductive base surface 6 at its lower end galvanically or capacitively. In particular with a particularly small antenna height 9, the impedance matching can be improved in that this coupling of the coupling conductor 35 to the conductive base surface 6 takes place via a dipolar coupling network 36 comprising blind elements. It can also be advantageous in a special case to design the coupling network 36 suffering slightly from loss in order to observe a specific VSWR value at the lower frequency band of the lower band while accepting radiation losses which are as small as possible.

### REFERENCE NUMERAL LIST

Broadband monopole antenna 0, 0a
Upper band monopole 1, 1a
Lower band monopole 2, 2a
Antenna connection site 3
Triangular structure 4
Antenna end connection point 5
Conductive base surface 6
Ground connection point 7
Upper band monopole height 8
Antenna height 9
Roof capacitor 10
Frame structure 11
Triangle opening angle 12
Spacing 13
Strip conductor width 14
Conductor strip 15, 15a, 15b
Rectangular structure 16
Cone opening angle in the y direction 17
Cone opening angle in the x direction 17a
Conical monopole 18
Roof lamella 19, 19a, 19b
Strip-shaped lamellas 20
Strip width 21
Vertical extent 22
Horizontal extent 23
Meandering shape 24
Annular satellite reception antenna 25, 25a, 25b
Interdigital structure 26
Parallel capacitance 27
Parallel inductance 28
Parallel oscillating circuit 29
Conical lamella 30, 30a, 30b
Remaining strip 31
Cover hood 32
Electrically conductive film 33
Sectional lines of the dielectric board 34
Coupling conductor 35
Coupling network 36
Coupling conductor width 37

1. A vertical broadband monopole antenna for vehicles for two frequency bands, namely a lower band (U) for lower frequencies and an upper band (O) for higher frequencies, separated by a frequency gap and both disposed in the decimeter wavelength spectrum, for transmitting and/or receiving using terrestrially broadcast, vertically polarized radio signals over a substantially horizontal conductive base surface as a vehicle ground, having an antenna connection site located in the monopole nadir, comprising the following features:
the broadband monopole antenna is designed from a self-supporting electrically conductive structure which is oriented above and substantially perpendicular to the base surface;
the electrically conductive structure comprises at the lower end of the broadband monopole antenna a triangular structure standing on its apex and having a substantially horizontally oriented baseline, the apex of the triangular structure forming an antenna connection point of the antenna connection site;
the electrically conductive structure comprises a roof capacitor substantially designed as a rectangular structure adjacent to and below the upper end of the broadband monopole antenna;
the triangular structure and the rectangular structure are connected inductively with high impedance by at least one conductor strip for separating radio signals in the upper band.

2. The broadband monopole antenna of claim 1,
wherein
the electrically conductive structure has at least two spaced apart conductor strips, whereby a frame structure is formed comprising the triangular structure, the rectangular structure and the conductor strip.

3. The broadband monopole antenna of claim 1,
wherein
the conductor strip or strips comprise meandering shapes for a frequency-selective separation.

4. The broadband monopole antenna of claim 1,
wherein
the internal angle at the apex of the triangular structure amounts approximately to between 30 and 90 degree.

5. The broadband monopole antenna of claim 1,
wherein
the triangular structure is designed by strip-shaped lamellas arranged fan-like in a plane of the triangle and running together at the apex.

6. The broadband monopole antenna of claim 5,
wherein
at least one annular satellite reception antenna which is arranged concentrically to the antenna connection site is present above the conductive base surface.

7. The broadband monopole antenna of claim 1,
wherein
to improve the electromagnetic decoupling, the rectangular structure is substantially formed by strip-shaped roof lamellas (19, 19a, 19b) which extend vertically and electrically conductively separate from one another, but contiguous at their upper end via a remaining strip (31).

8. The broadband monopole antenna of claim,
wherein
the strip-shaped lamellas which run together in the apex are angled out of the plane of the triangular structure such that they extend substantially on the jacket surface of a cone standing on its apex and having a circular or elliptical cross-section.

9. The broadband monopole antenna of claim 7,
wherein
the roof lamellas are angled in opposite senses following one another in a manner such that they are arranged in V shape in a projection onto a plane extending transversely to the strip.

10. broadband monopole antenna of claim 5,
wherein
the lamellas running together at the apex are angled, in opposite senses following one another, from the plane of the triangular structure such that they are arranged in V shape in a projection onto a plane extending transversely to the triangular structure.

11. The broadband monopole antenna of claim 1,
wherein
the broadband monopole antenna is arranged beneath a cover hood, and in that the at least one conductor strip is passed at least in part and in particular as far as possible along the inner wall of the cover hood.

12. The broadband monopole antenna of claim 1,
wherein
the electrically conductive structure comprises electrically conductive sheet metal and only one self-supporting conductor strip is present whose strip conductor width is in particular smaller than or equal to 7 mm.

13. The broadband monopole antenna of claim 1,
wherein
the electrically conductive structure is given by a metallic coating on a circuit board whose contour substantially follows the outlines of the electrically conductive structure of the broadband monopole antenna.

14. The broadband monopole antenna of claim 1,
wherein
the mirror image of the broadband monopole antenna at the conductive base surface is replaced on its being dispensed with by a further broadband monopole antenna which is the same as it in a manner such that a dipole is present symmetrical to the plane of the conductive base surface and a symmetrical antenna connection site of this dipole is formed between the antenna connection point of the broadband monopole antenna and the antenna connection point of the further broadband monopole antenna which is mirrored correspondingly at the conductive base surface.

15. The broadband monopole antenna of claim 1,
wherein
a coupling conductor is present which is connected at its upper end to the roof capacitor and which is coupled at its lower end to the conductive base surface.
